(19) United States
(12) Patent Application Publication
(10) Pub. No.: US 2012/0145979 A1
(43) Pub. Date: Jun. 14, 2012

(54) HOIST SYSTEM AND METHOD OF HOISTING

(76) Inventor: James Rogerson, Kintore (GB)

(21) Appl. No.: 13/377,040

(22) PCT Filed: Apr. 22, 2010
(86) PCT No.: PCT/GB2010/050652

§ 371 Date: Mar. 2, 2012

(30) Foreign Application Priority Data
Jun. 8, 2009 (GB) 0909800.5

(51) Int. Cl. B66D 1/58; B66D 1/26; B66D 3/06

(52) U.S. Cl. 254/285

(57) ABSTRACT

A hoist system comprises a first line (112) and a first pulley (114), the first line extending around the first pulley to provide for raising and lowering a load attached to the first line and further comprises a second line (111) and a second pulley (113), the second line extending around the second pulley, the first pulley being suspended on the second line.

The present invention relates to a hoist system and more specifically a personnel hoist for use on an offshore oil and/or gas producing platform. Most oil and gas producing platforms use a derrick to position the drill string and/or drill pipe above the wellbore. As part of the normal operations on the platform, it is often necessary for personnel to work or operate machinery at one or more worksites on the derrick. This requires a hoist system to raise the personnel from the deck to an elevated position on the derrick.

Most existing hoist or winch systems comprise a powered motor, gearbox and variable throttle. To control the movement of the user of an existing personnel hoist, the operator must slowly and carefully operate the throttle. This requires considerable skill as it is difficult to control the torque produced by the motor. Controllability of the lifting wire is key to the safe operation of any personnel hoist.

The users of existing personnel hoists are all too often seriously or fatally injured when one or more of their limbs become trapped during a hoisting operation. To avoid entrapment the user must communicate the likelihood of imminent danger to the hoist operator and the operator must then immediately stop the winch. Working conditions on offshore oil and/or gas producing platforms are often unpredictable and communication between the user and operator can be difficult. Safe operation of an existing personnel hoist system relies on the operator having an unobstructed view of the user.

Accidents also occur when a component such as a section of tubing or casing descends quickly towards the platform deck. When this happens there is a risk that the user of a personnel hoist will become snagged on the descending object. Injury to the user of an existing personnel hoist is then almost inevitable since to avoid injury, the operator must release the hoist wire the instant the object starts to descend and ensure the user descends at the same speed as the object.

Embodiments of the present invention aim to reduce the risk of injury, to the user of a personnel hoist, caused by entrapment or the user becoming snagged on a descending object.

According to a first aspect of the present invention there is provided a hoist system comprising a first line and a first pulley, the first line extending around the first pulley to provide for raising and lowering a load attached to the first line and further comprising a second line and a second pulley, the second line extending around the second pulley, the first pulley being suspended on the second line.

Optionally, there is further provided a means to measure tension on the first and/or second lines.

Optionally, there is further provided a tension controlling means operably connected to the first and/or second lines.

Optionally, the tension controlling means is a hydraulic system comprising one or more of a counter balance valve and vented relief valve.

Advantageously, in use, the second line pays out when the tension exerted on the first line exceeds a predetermined value.

Optionally, there is further provided at least a first and a second reel, the first line attached to the first reel, the second line attached to the second reel.

Optionally, the first line extends from the first reel to a wheel of the first pulley and from the wheel of the first pulley to the load; the second line extends from the second reel to a wheel of the second pulley and from the wheel of the second pulley to a body of the first pulley.

Advantageously, the first reel is mounted on a first shaft and the second reel is mounted on a second shaft.

Preferably, a first rotation means is mounted on the first shaft and a second rotation means is mounted on the second shaft.

Optionally, the rotation means comprises a handle, typically the rotation means comprise a motor, preferably the motor comprises a hydraulic motor.

Advantageously, there is further provided one or more hydraulic systems, a first hydraulic system comprising a first hydraulic motor, the first hydraulic motor being the first rotation means; a second hydraulic system comprising a second hydraulic motor, the second hydraulic motor being the second rotation means.

Typically, in use, the first hydraulic system powers the first hydraulic motor that rotates the first reel; the second hydraulic system powers the second hydraulic motor that rotates the second reel.

Advantageously in use, rotation of the first reel raises or lowers a load attached to the first line.

Typically, the circumference of a winding surface and/or diameter of the reels are determined by the minimum bend limits and operational length requirements of the line.

Typically, the circumference of the winding surface of the first reel is greater than the circumference of the winding surface of the second reel. Preferably, the circumference of the winding surface of the first reel is between 32 cm and 40 cm, the circumference of the winding surface of the second reel is between 18 cm and 26 cm. Advantageously, the circumference of the winding surface of the first reel is 36 cm, the circumference of the winding surface of the second reel is 22 cm.

Optionally, the winding surface of the first and/or second reel is grooved.

Optionally, a tensioner is operably connected to the first line. Preferably, the tensioner is a slack wire roller that keeps the first line under tension. Optionally, the slack wire roller can be disabled allowing the first line to pay out from the first reel and providing line for the user to work over a substantially horizontal work area.

Optionally, the line comprises one or more of wire, chain, cord, rope, twine and string. Optionally, the line is one or more of 10 mm in diameter; composed of non rotational stainless steel; and has a safety factor of 5-1.

Advantageously, the second pulley is securable to a derrick of an oil and/or gas producing platform.

Advantageously, the first and second shafts are mounted to a base unit, secured to the deck of an oil/or gas producing platform.

Typically, in use, the first pulley is in a docking station of the second pulley.

Optionally, the first and/or second reels comprise one or more brakes. Preferably, the first reel comprises two brakes, one on a motor spindle and one on the first shaft.

The load is one or more of the first and/or second line; a lifting hook; personnel; and auxiliary equipment.

According to another aspect of the present invention there is provided a method of operating a hoist system, the method including the steps of:
(a) raising or lowering a load on a first line; and
(b) controlling the position of the load on the first line using the second line.

Optionally, the method comprises the step of monitoring tension exerted on the first line and/or a second line.

Advantageously, the position of the load on the first line is controlled using the second line when tension exerted on the first line exceeds a predetermined value.

Optionally, the method comprises the step of rotating a first reel and/or a second reel.

Optionally, the method comprises the step of paying out or retracting the first line attached to the first reel and/or the second line attached to the second reel.

Advantageously, the method comprises rotating a first shaft using a first rotation means, the first reel being mounted to the first shaft.

Advantageously, the method comprises rotating a second shaft using a second rotation means, the second reel being mounted to the second shaft.

Advantageously, the pay out rate of the second line from the second reel is greater than the rate at which the first line can be retracted onto the first reel.

Typically, the sum of the tension exerted by the load on the first line is less than or equal to 150 kg.

Optionally, the second rotation means pays out the second line from the second reel when the tension exerted on the first line exceeds the tension exerted by the load on the first line.

Advantageously, in use, the second rotation means pays out the second line from the second reel when the tension exerted on the first line is greater than 150 kg.

Preferably, the second rotation means pays out the second line from the second reel when the tension exerted on the first line is more than 15% greater than the tension exerted by the load on the first line.

Optionally, the second rotation means can be used to pay out the second line from the second reel without the use of electrical power.

Optionally, the hoist system raises or lowers personnel. Optionally, the hoist system raises or lowers personnel from one work area of an oil and/or gas producing platform to another work area. Typically, the hoist system is a personnel hoist.

Optionally, the personnel hoist operates between various levels on the oil and/or gas producing platform and a fixed point. Preferably the fixed point is mounted at the top of the derrick.

Advantageously, in use, the operator of the personnel hoist controls the flow path and/or flow rate of hydraulic fluid in a first system comprising the first reel. Optionally, the flow path and/or flow rate of hydraulic fluid in a second system comprising one or more of a counter balance valve and vented relief valve is predetermined during manufacture of the hoist system.

Advantageously, operation of the first rotation means raises or lowers the load; operation of the second rotation means ensures a lifting point on the first line and the load attached thereto remain at a constant distance apart, when the tension exerted by the load on the first line is greater than a predetermined value.

Embodiments of the present invention will now be described by way of example only and with reference to and as shown in the accompanying drawings, in which:—

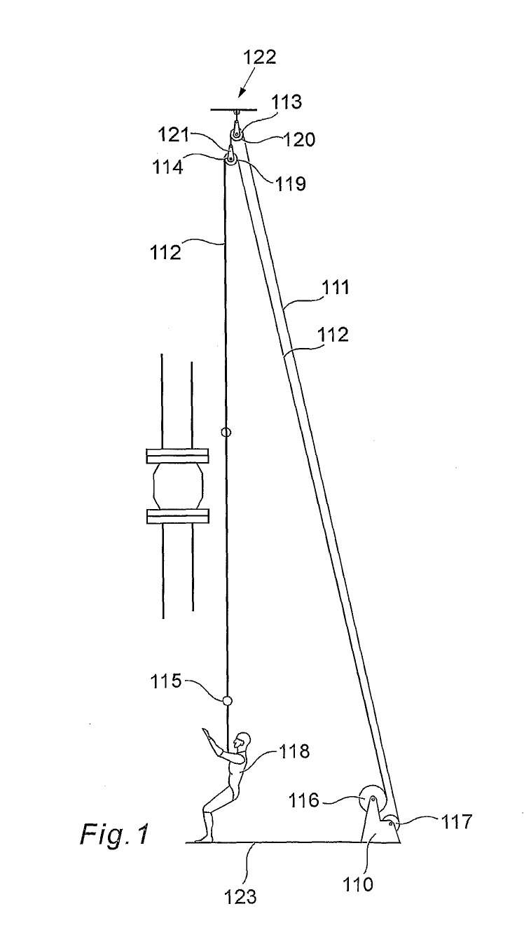

FIG. 1 is a schematic view of a personnel hoist in accordance with one aspect of the present invention;

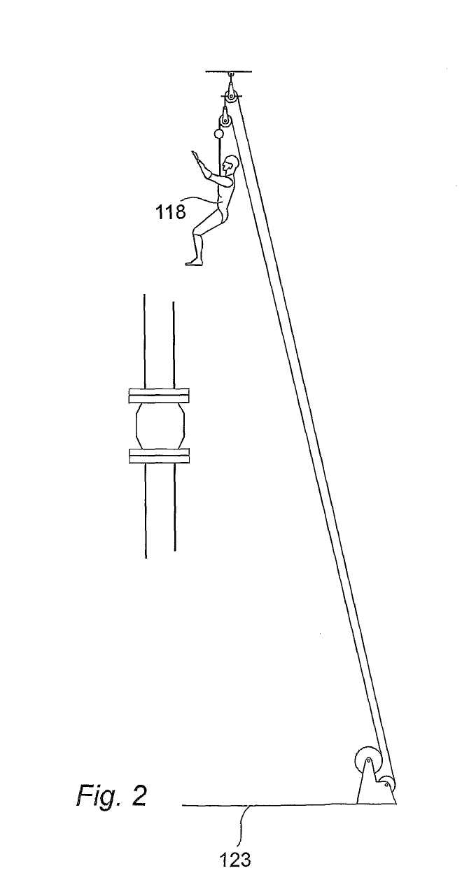

FIG. 2 is a schematic view of a personnel hoist in accordance with one aspect of the present invention, showing the user of the hoist system at an elevated position;

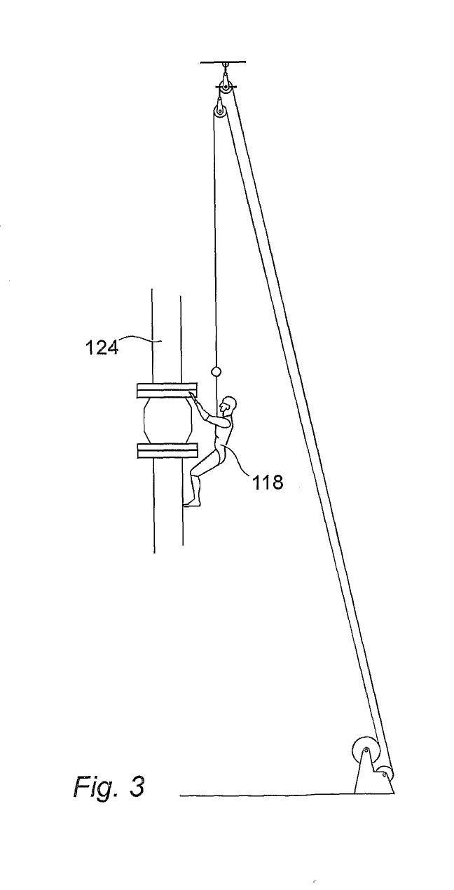

FIG. 3 is a schematic view of a personnel hoist in accordance with one aspect of the present invention showing the user working on a section of casing, the casing being suspended above the platform deck;

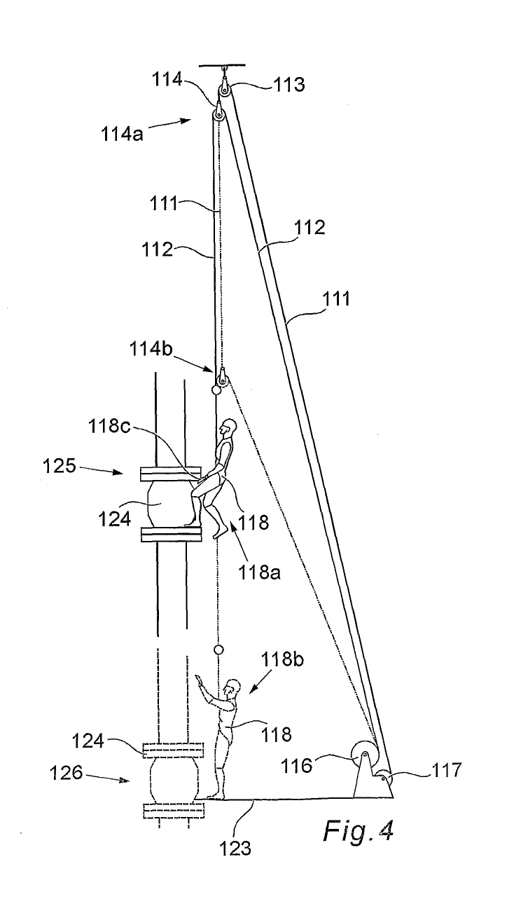

FIG. 4 is a schematic view of a personnel hoist in accordance with one aspect of the present invention showing the entrapment of the user on the section of casing and the users position relative to the casing in the event that the casing descends to the platform deck;

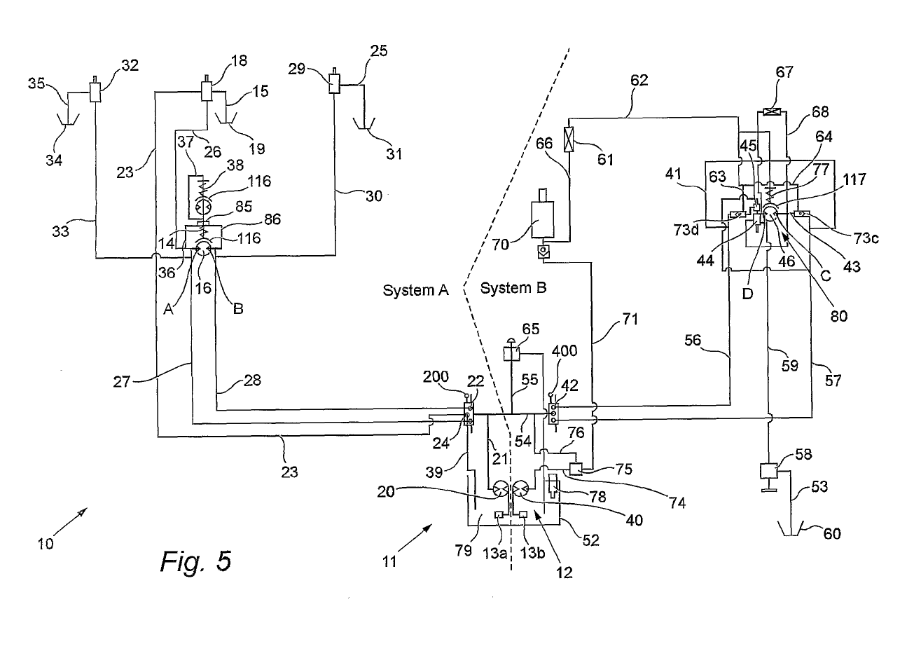

FIG. 5 is a schematic diagram of the hydraulic flow lines and control devices of the hydraulic systems controlling the first and second wires;

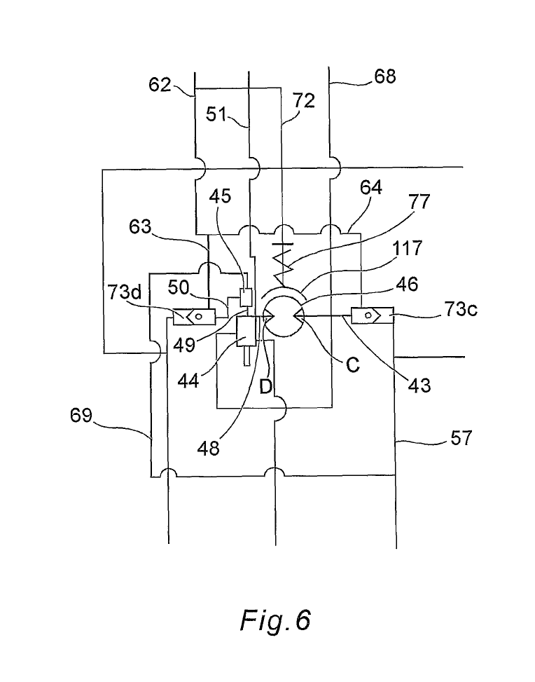

FIG. 6 is an enlarged view of the hydraulic flow lines and control devices of the hydraulic system controlling the second wire;

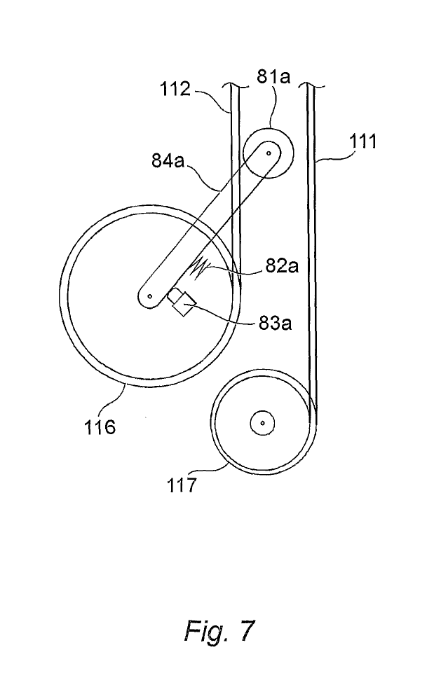

FIG. 7 is a schematic diagram showing the slack wire roller when the first wire is taught;

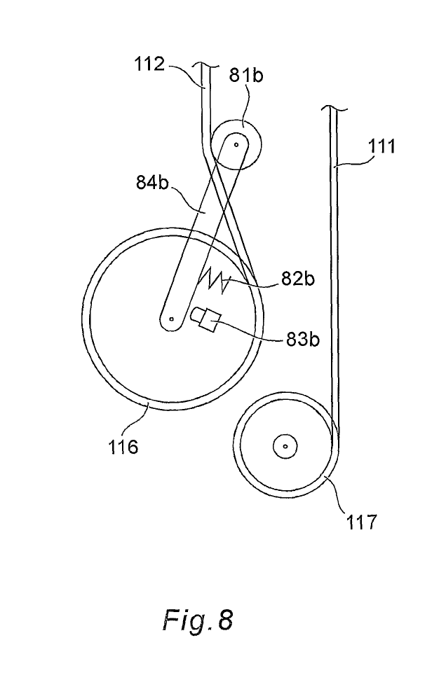

FIG. 8 is a schematic diagram showing the slack wire roller when the first wire is slack, and

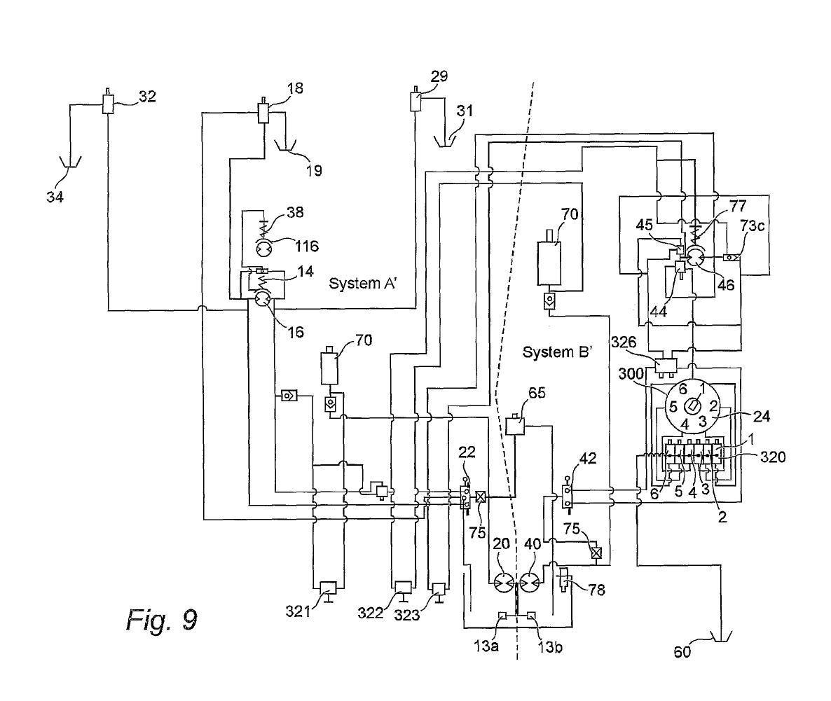

FIG. 9 is a schematic diagram of an alternative hydraulic system controlling the first and second wires.

FIG. 1 shows an exemplary embodiment of a personnel hoist comprising a winch unit 110; reels 116, 117; wires 112, 111; pulleys 114, 113; and lifting hook 115. When in use the man 118 is raised or lowered using the wire 112. Wire 111 only pays-out from the reel 117 when the tension on the wire 112 exceeds a predetermined valve.

The particular embodiment described herein comprises a winch unit 110, housing two reels 116 and 117. The winch unit 110 is mounted on the deck 123 of an oil and/or gas producing platform. The pulley 113 is mounted at a suitable anchor point 122 on a derrick (not shown).

Reel 116 is mounted to a shaft (not shown) and the shaft is secured to the winch unit 110. Reel 117 is mounted to another shaft (not shown) and this shaft is also secured to the winch unit 110.

Wire 112 is stored on the winding surface of reel 116 and extends from the reel 116 to a wheel 119 of pulley 114 and from the wheel 119 to the lifting hook 115. Wire 111 is stored on the winding surface of reel 117 and extends from the reel 117 to the wheel 120 of pulley 113 and from the wheel 120 to a body 121 of the pulley 114.

The wires 111 and 112 have a safety factor rating of 5:1. The wires 111 and 112 also have a diameter of 10 mm and a minimum bend radius of 180 mm, giving a ratio of 18:1.

The circumference of the winding surface of the first reels 116 and 117 is determined by the minimum bending radius of the wires 112 and 111, the wire speed and the wire storage required. As the circumference of the winding surface increases, the pressure of hydraulic fluid required to rotate the reel also increases and the sensitivity and/or accuracy to which the wire 112 and 111 can be controlled decreases.

The circumference of the winding surface of the reel 116 is 36 cm (14 inches). The circumference of the winding surface of the reel 117 is 22 cm (8⅝ inches). The reels 116 and 117 have a length of 60 cm (24 inches). The operational length of the wire 112 on the reel 116 is 60 m (200 ft); the operational length of the wire 111 on the reel 117 is also 60 m (200 ft).

FIG. 1 illustrates the setup of the personnel hoist system. The wires 112 and 111 are directed through and/or attached to the pulleys 114 and 113 as described above. The lifting hook 115 is then secured to the wire 112. The tension at which the wire 111 will payout from the reel 117 is then set to 165 kN, corresponding to a weight of 165 kg. The maximum permissible weight of a user attached the wire 112 is 150 kg.

The tension exerted on the wire 111 is greater than the tension exerted on the wire 112. Further explanation of the tension of the wire 111 is given below.

In use, the operator controls the rotation of the reel 116. To raise the man 118, secured to the lifting hook 115, from the deck 123 to an elevated position closer to the anchor point 122 on the derrick (not shown), the operator (not shown) operates the hydraulic motor (not shown) to retract the wire 112 onto the winding surface of the reel 116. To lower the man 118, secured to the lifting hook 115, from an elevated position above the deck 123, the operator (not shown) operates the hydraulic motor (not shown) to controllably rotate the reel 116 and pay out the wire 112 from the winding surface of the reel 116.

During normal operation the reel 117 does not rotate. Wire 111 extends from the reel 117 to the pulley 113 and suspends the pulley 114 above the deck 123. During normal operation the relative position of the pulleys 113 and 114 does not change; the pulley 114 remains in a docking station of the pulley 113 (not shown).

FIGS. 2, 3 and 4 show various stages of the operation of the personnel hoist, including operation of the reel 117 to pay out the wire 111.

FIG. 2 shows an exemplary embodiment of the personnel hoist as shown in FIG. 1 showing the man 118 elevated above the surface of the deck 123.

FIG. 3 shows an exemplary embodiment of the personnel hoist as shown in FIG. 1 showing the man 118 elevated above the surface of the deck 123 and working on a section of casing 124.

FIG. 4 shows an exemplary embodiment of the personnel hoist as shown in FIGS. 1, 2 and 3. FIG. 4 shows the casing 124a suspended from the derrick (not shown) above the deck 123. The man 118a is shown with his hand 118c caught on the casing 124 at a raised position 125. In this position 125 the pulley 114 is suspended at point 114a proximate to the other pulley 113. FIG. 4 shows the downward movement of the casing 124 from a suspended location 125 to a location 126 adjacent to the deck 123. The man 118 and his hand 118c caught on the casing 124 are pulled down towards the deck 123 by the casing 124. This downwards movement of the man 118 and his hand 118c from position 118a to the lower position 118b is facilitated by rotation of the reel 117. The reel 117 rotates when the tension on the wire 111 exceeds 165 kN, corresponding to a weight of 165 kg. The pulley 114 secured to the wire 111 moves with the man 118. As the pulley 114 is pulled down towards the deck 123, the wire 111 pays out from the reel 117. This ensures the man 118 and his hand 118c maintain the same relative position to the casing 124 at both the elevated 125 and lower 126 locations. The wire 111 pays out from the reel 117, allowing the pulley 114a to be lowered so as to suspend the pulley 114 at a point 114b remote from the other pulley 113. Pulley 113 remains attached to the derrick (not shown) at the anchor point 122.

FIG. 5 shows an exemplary embodiment of a hydraulic system 10 used to power and control the personnel hoist system shown in FIGS. 1 to 4. The hydraulic system comprising two separate systems A and B. Hydraulic system A comprises a pump 20 and motor 16 that are operably connected to and used to control rotation of the reel 116, the wire 112 and lifting hook 115 (as shown in FIGS. 1 to 4). Hydraulic system B comprises a pump 40 and motor 46 that are operably connected to and used to control rotation of the reel 117 and the wire 111 (as shown in FIGS. 1 to 4). FIG. 6 shows the part of the hydraulic system B in more detail.

The particular embodiment shown in FIG. 5 and described herein comprises a power pack 11, the power pack 11 comprising a double pump unit 12 and suction strainers 13a and 13b. The double pump unit 12 houses a first pump 20 and a second pump 40. The first pump 20 is in fluid communication with control valve 22 via pipe 21. The control valve 22 has one inlet port, connected to which is pipe 21 and three outlet ports. Valve 22 has a high pressure carryover configuration that operates when the control lever 200 is in the neutral position. In this configuration pipe 21 is in fluid communication with the inlet port of control valve 22 and an outlet port. Pipe 23 connects an outlet port of control valve 22 and the inlet port of a two-way slack wire valve 18. Pipe 15 is in fluid communication with an outlet port of slack wire valve 18 and tank 19. Pipe 26 is in fluid communication with slack wire valve 18 and port A of the first motor 16. The first motor 16 is connected to the first reel 116. In an alternative configuration control valve 22 provides fluid communication between pipe 21 and pipe 27. Pipe 27 is in fluid communication with control valve 22 and port A of the motor 16. In a further alternative configuration control valve 22 provides fluid communication between pipe 21 and pipe 28. Pipe 28 is in fluid communication with control valve 22 and port B of the motor 16. Control valve 22 is configured such that pipe 21 cannot simultaneously be in fluid communication with pipe 23, pipe 27 and pipe 28.

Pipe 28 is in fluid communication with port B of motor 16 and pipe 30 that connects pipe 28 with an inlet port of valve 29. Pipe 25 is in fluid communication with an outlet port of valve 29 and tank 31. Pipe 27 is in fluid communication with port A of motor 16 and an inlet of pipe 33 that connects pipe 27 with an inlet port of valve 32. Pipe 35 is in fluid communication with an outlet port of valve 32 and tank 34.

Pipe 36 provides fluid communication between port A and shuttle valve 85. Pipe 86 provides fluid communication between port B and shuttle valve 85. The first brake 14 and a second brake 38, also acting on reel 116, are in fluid communication via pipe 37.

The second pump 40 is in fluid communication with the inlet port of accumulator charge valve 75 via pipe 74. Accumulator charge valve 75 has two outlet ports. Pipe 76 is connected to an outlet port and provides fluid communication between accumulator valve 75 and an inlet port of control valve 42. An outlet port of accumulator charge valve 75 is connected to pipe 71, providing fluid communication between accumulator charge valve 75 and an accumulator 70. Accumulator 70 is also in fluid communication with valve 61 via pipe 66. Pipe 62 provides fluid communication between valve 61 and valves 73c and 73d Control valve 42 has two outlet ports. Pipe 57 provides fluid communication between an outlet port of control valve 42 and valve 73c. Pipe 56 provides fluid communication between another outlet port of control valve 42 and valve 73d. Valve 73c is in fluid communication with port C of a second motor 46 via pipe 43. Valve 73c is also in fluid communication with valve 73d via pipe 64. Pipe 41 fluidly connects pipe 56 and pipe 57.

The second motor 46 is operably connected to a second reel 47 and is in fluid communication with vented relief valve 44 via pipe 48. Vented relief valve 44 is in fluid communication with counter balance valve 45 via pipe 49. Counter balance valve 45 and valve 73d are in fluid communication via pipe 50. Pipe 51 is in fluid communication with vented relief valve 44, pipe 48 and valve 67. Valve 67 is also in fluid communication with vented relief valve 44 via pipe 68. Pipe 69 provides fluid communication between counter balance valve 45 and valve 73c. Brake 77 is in fluid communication with pipe 62 via pipe 72.

Dump valve 65 is in fluid communication with both system A and system B. Pipe 55 provides fluid communication between the dump valve 65 and pipe 54 that fluidly connects the inlet of control valve 22 of system A with the inlet of control valve 42 of system B.

Relief valve 58 is in fluid communication with vented relief valve 44 via pipe 59 and tank 60 via pipe 53.

Pipe 39 is in fluid communication with valve 22 and the oil 79 in tank 52. The first pump 20 and second pump 40 are submerged in the oil 79. The filter 78 is mounted on the side of the tank 52 and below the surface of the oil 79.

The relief valve 58, valves 22, 42, 58 and 65 are all mounted on the control panel.

When the power pack 11 is switched on, the accumulator 70 is charged up. During charge-up oil passes through valve 75 to accumulator 70 via pipe 71. Once the accumulator 70 is charged, the oil flow is switched to pipe 76 to control operation of the second reel. Valve 61 is then opened and oil from the accumulator 70 passes along pipes 62, 63 and 64 to close pilot operated check valves 73c and 73d. Operation of valves 73c and 73d blocks the oil from returning to the tank and releases the brake 77. Oil is then able to flow to the lower side 80 of the motor 46 to replace any oil lost through the case drain of the motor (not shown). Pipe 68 allows oil to pass from port C to port D.

In standby mode the pump 20 pressurises the oil in pipe 21 that connects to the inlet port of valve 22. With the control lever 200 in the neutral position, pump 20 pumps oil through pipe 23 to the valve 18 and then to the tank 19. Opening the valve 18 directs oil from pipe 23 via pipe 26, to port A of motor 16. This operates the slack wire roller (not shown) to take up any slack wire (not shown). Under normal operation and without intervention from the operator, the slack wire roller keeps the first line under tension.

Operation of the control lever 200 directs the flow of oil from pipe 21 through valve 22 to pipe 27 or pipe 28. The direction of rotation of the reel 116 is controlled by the lever 200. Oil directed through pipe 27 to port A rotates the motor 16 anti-clockwise. The motor 16 and reel 116 (as shown in FIGS. 1 to 4) are mounted to a shaft (not shown). Rotating the motor 16 anti-clockwise retracts the wire 112 onto the reel 116 and raises the lifting hook 115 (as shown in FIGS. 1 to 4). Oil directed through pipe 28 to port B rotates the motor 16 clockwise. Rotating the motor 16 clockwise pays out the wire 112 from the reel 116 and lowers the lifting hook 115 (as shown in FIGS. 1 to 4).

Valve 29 is closed during normal operation. When opened valve 29 allows oil to pass from port B along pipe 30 and 25 to tank 31. Valve 32 is also closed during normal operation. When opened, valve 32 allows oil to pass from port A along pipe 33 and 35 to tank 34. When valves 29 and 32 are opened, the resultant flow of oil into tanks 31 and 34 respectively causes the reel 116 to stop rotating and stop paying out or retracting the wire (not shown).

In standby mode the second pump 40 pressurises the oil in pipe 41 that connects to valve 42. Operation of control lever 400 directs the flow of oil from pipe 76 through valve 42 to pipe 56 and port D or pipe 57 and port C. In this configuration port D functions as a heave port, supplying constant tension to the wire 111, (as shown in FIGS. 1 to 4).

Mounted on the motor 46 is a counter balance valve 45 and a vented relief valve 44. Another relief valve 58 is in fluid communication with the relief valve 44 via pipe 59. Valve 58 is mounted on the control panel (not shown) and permits the operator to maintain a constant tension on the wire 111 (as shown in FIGS. 1 to 4). Adjusting valve 58 adjusts the oil pressure acting against valve 44. Reducing the oil pressure on valve 44 and allowing oil to pass from port D to port C causes the wire 111 (as shown in FIGS. 1 to 4) to pay out. Increasing the oil pressure on valve 44 slows down or stops the wire 111 (as shown in FIGS. 1 to 4) paying out.

Dump valve 65 is used to isolate valve 18. Under normal operating conditions this ensures the wire 111 (as shown in FIGS. 1 to 4) is under constant tension. Dump valve 65 also isolates both reels 116 and 117 (as shown in FIGS. 1 to 4) and allows the man 118 (as shown in FIGS. 1 to 4) to generate some slack wire and prevents the operator from rotating the reels.

The man 118 may need to perform operations at a remote worksite where he needs slack wire to gain adequate access. When the man 118 has finished performing the operation he must be re-suspended. To achieve this the operator closes the dump valve 65. With a restricted flow of oil, any slack wire will be taken-up and the operator will be able to regain control of the personnel hoist.

FIGS. 7 and 8 show the slack wire roller 81a and 81b. FIG. 7 illustrates the configuration of the slack wire roller 81a, spring 82a and valve 83a when the wire 112 is under tension. FIG. 8 illustrates the configuration of the slack wire roller 81b, spring 82b and valve 83b when the wire 111 is slack.

FIG. 7 illustrates the wire 112 under tension, pushing back the arm 84a to compress the spring 82a and close the valve 83a. In this configuration the operator (not shown) can direct oil through system A (as shown in FIG. 5) to rotate the reel 116.

FIG. 8 illustrates the wire 112 being slack and the spring 82b pushing forward the arm 84b to open the valve 83b. In this configuration the operator (not shown) cannot direct oil through system A (as shown in FIG. 5) and can therefore not rotate the reel 116.

Modifications or improvements may be made to the present invention without departing from the scope of the invention. For example, the winch unit 110 of the above described embodiments may comprise an outer casing of a generally rectangular form within which the reels 116, 117 are housed. An opening may be formed in the upper part of the casing, generally on the upper surface, through which the wires 111, 112 extend from the reels 117, 116 to the pulleys 113, 114. A barrier may be provided across the opening of the casing to prevent any dirt, debris or equipment dropped from a height above the casing from entering the casing and fouling the wires on the reels. Such a barrier would not obstruct the wires as they are wound onto and off of the reels. It is envisaged that the barrier may comprise one or more plastic sheets, brushes or fibre mats which extend over the opening without disrupting passage of the wires.

In a further modification which may be applied to any of the described embodiments of the present invention, a roller may be provided adjacent the or each reel of the winch unit. The roller has a resilient outer surface or coating and preferably comprises polyurethane. The roller is selectively moveable towards and away from the reel such that in use, when the roller is moved towards the reel it presses the wire against the reel and assists in maintaining a positive contact between the wire and the reel which prevents the wire from sliding from or jumping out of contact with the reel. This provides an additional safety component to the present invention.

In a still further modification additional safety features may be incorporated into the hoist system of the present invention. FIG. 9 shows an alternative embodiment of a hydraulic system for use in controlling the operation of the hoist of the present invention. Like numerals are used to refer to common components. As with the hydraulic system illustrated in FIG. 5, in this embodiment, the hydraulic system comprises two systems A′ and B′ in which hydraulic system A′ controls rotation of the reel 116 and wire 112 and hydraulic system B′ controls rotation of reel 117 and wire 111.

In this embodiment the relief valve 58 between the vented valve 44 and the tank 40 of FIG. 5 is replaced by a multi position selector valve 300 as shown in FIG. 9. The selector valve is shown as having six positions, each of which represents a different load to be carried by the hoist, although any number of different positions and different loads may be envisaged.

The selection of each position on the selector valve opens a respective flow path 310 between the pump and the second motor which passes through respective relief valves 320, there being a relief valve provided for each position of the selector valve. Each of these relief valves is set to open at a different pressure which represents a different tension on the line 111.

This allows the tension on wire 111 to be set according to the weight of the user of the hoist by dialling the selector valve to the appropriate position. Once the tension on the wire is set it will remain so until changed by altering the position of the selector valve.

In this embodiment, selection of a specific load is set into the hydraulic unit and once selected and in the operational mode, the load cannot be changed except by passing through the neutral position during which time any user will be held under braking and therefore in a safe position.

This prevents the unintentional resetting of the load during use which could represent a danger to the user of the hoist where the load is set to indicate his weight and ensures that each time a different user is attached to the hoist, the constant tension on line 111 can reflect his weight.

Safety means may be provided in the form of an emergency raise and lower system and braking release such as illustrated in FIG. 9 and comprising valves 321, 322 and 323 to raise or lower an operator on the hoist in an emergency situation and to effect a controlled decent of the operator. The safety system may further comprise a duel pilot operated check valve 326 on the second drum.

As a further modification, embodiments of the present invention may be provided with a safety mechanism to allow the operator to lock the drum 117 in an operating condition or a neutral condition. It is envisaged that a lever will be provided on the control unit and the operator may selectively lock the lever in one or other position which would prevent the operator being able to lower a user on the hoist with the constant tension drum thus ensuring correct operation of the winch and retaining all safety features during winch operations. The safety mechanism may comprise a spring loaded bolt which may be L-shaped in configuration and adapted to pass into or through an aperture in the control lever to prevent unintentional movement of the control lever. In some embodiments, the safety mechanism may be mounted under a panel on the control unit to provide an additional measure against unintentional unlocking of the lever.

The person skilled in the art will appreciate that the personnel hoist described herein is not limited to use on an offshore oil and gas producing platform. The hoist system is equally well suited for use on land based platforms, the general construction industry, the servicing of electricity pylons or other structures when elevated access is required. The personnel hoist system of the present invention helps to reduce the likelihood of injury to the user of the hoist caused by entrapment or the user becoming snagged on a descending object.

1. A hoist system comprising:
a first line and a first pulley, the first line extending around the first pulley to provide for raising and lowering a load attached to the first line;
a second line and a second pulley, the second line extending around the second pulley, the first pulley being suspended on the second line; and
wherein the second line is arranged to pay out when the tension on the first line exceeds a predetermined value.

2. A hoist according to claim 1, further comprising a tension measuring device configured to measure tension on the first and/or second lines.

3. A hoist according to claim 1, further comprising a tension controller operably connected to the first and/or second lines.

4. A hoist according to claim 3, wherein the tension controller comprises a hydraulic system.

5-6. (canceled)

7. A hoist according to claim 1, including at least a first and a second reel, the first line being wound on the first reel, and the second line being wound on the second reel.

8. A hoist according to claim 7, wherein the first and second pulleys each comprise a wheel and wherein the first line extends from the first reel to the wheel of the first pulley and from the wheel of the first pulley to the load and the second line extends from the second reel to the wheel of the second pulley and from the wheel of the second pulley to a body of the first pulley.

9. A hoist according to claim 7, wherein the first reel is mounted on a first shaft and the second reel is mounted on a second shaft.

10-14. (canceled)

15. A hoist according to claim 1, further comprising first and second hydraulic systems.

16. A hoist according to claim 7, wherein the first and second reels each have a winding surface to receive the line, and wherein each winding surface has a circumference, and wherein the circumference of the winding surface of the first reel is greater than the circumference of the winding surface of the second reel.

17. A hoist according to claim 1, wherein the winding surface of the first and/or second reel is grooved.

18. A hoist according to claim 3, wherein the tension controller comprises a slack wire roller that keeps the first line under tension.

19. (canceled)

20. A hoist according to claim 1, wherein the second pulley provides a docking station for the first pulley.

21. A hoist according to claim 7, wherein the first and/or second reels comprise one or more brakes.

22-23. (canceled)

24. A method of operating a hoist system, the method including the steps of:
(a) raising or lowering a load on a first line, the first line extending around a first pulley;
(b) controlling the position of the load on the first line using a second line extending around a second pulley, the first pulley being suspended on the second line: and
wherein the method includes the step of paying out the second line when the tension on the first line exceeds a predetermined value.

25. A method according to claim 24, further including the step of monitoring tension on the first line and/or a second line.

26. (canceled)

27. A method according to claim 24, wherein the first line is wound onto a first reel, and the second line is wound onto a second reel, and wherein the method includes the step of paying out or retracting the first line by rotating the first reel on which the first line is wound and/or paying out or retracting the second line by rotating the second reel on which the second line is wound.

28. A method according to claim 27, wherein the pay out rate of the second line from the second reel is greater than the rate at which the first line can be retracted onto the first reel.

29. A method according to claim 24, wherein the sum of the tension exerted by the load on the first line is less than or equal to 150 kg.

30. A method according to claim 24, wherein the second line is paid out when the tension exerted on the first line exceeds the tension exerted by the load on the first line.

31-32. (canceled)

33. A hoist according to claim 1, wherein the first pulley is suspended below the second pulley.

34. A hoist system comprising:
a first and a second reel;
a first line wound onto the first reel, and a second line wound onto the second reel;
a first pulley comprising a wheel and a body;
a load attached to the first line, the first line extending from the first reel around the wheel of the first pulley to the load to provide for raising and lowering the load;
a second pulley comprising a wheel, the second line extending from the second reel around the wheel of the second pulley to the body of the first pulley; and
wherein the first pulley is suspended on the second line.

35. A hoist system according to claim 34, the second line being arranged to pay out when the tension on the first line exceeds a predetermined value.
